(19) United States
(12) Patent Application Publication
(10) Pub. No.: US 2005/0242459 A1
(43) Pub. Date: Nov. 3, 2005

(54) Lignocellulosic composite material and method for preparing the same

(76) Inventors: Thomas G. Savino, Northville, MI (US); Sandra Bananto, Dearborn, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/835,134

(22) Filed: Apr. 29, 2004

(51) Int. Cl. B27N 3/00

(52) U.S. Cl. 264/109

(57) ABSTRACT

A lignocellulosic composite material and a method for preparing the lignocellulosic composite material are disclosed. The composite material includes lignocellulosic particles and a binder resin being a mixture of a polyisocyanate component and a release agent. The release agent is formed from a first component having hydroxyl groups and a second component having isocyanate groups in excess of the hydroxyl groups. The first component is selected from at least one of i) an acid phosphate and ii) pyrophosphates represented by those derived from the acid phosphates (i) and mixtures of the acid phosphates (i). The first component is passivated by mixing it with the second component which is preferably monomeric diphenylmethane diisocyanate selected from at least one of diphenylmethane-4,4′-diisocyanate, diphenylmethane-2,4′-diisocyanate, and diphenylmethane-2,2′-diisocyanate.

### BACKGROUND OF THE INVENTION

1) Field of the Invention

The subject invention relates to a lignocellulosic composite material and a method for preparing the lignocellulosic composite material.

2) Description of Related Art

Composite materials such as oriented strand board, Medium Density Fiberboard (MDF), agrifiber board, particle board, and flakeboard are generally produced by blending or spraying lignocellulosic particles or materials with a binder resin while the particles are tumbled or agitated in a blender or like apparatus. After blending sufficiently to form a uniform mixture, the particles are formed into a loose mat, which is compressed between heated platens or plates to set the binder and bond the flakes, strands, strips, pieces, etc., together in densified form. Conventional processes are generally carried out at temperatures of from about 120 to 225° C. in the presence of varying amounts of steam, either purposefully injected into or generated by liberation of entrained moisture from the wood or lignocellulosic particles. These processes also generally require that the moisture content of the lignocellulosic particles be between about 2 and about 20% by weight, before it is blended with the binder.

The lignocellulosic particles can be in the form of chips, shavings, strands, wafers, fibers, sawdust, bagasse, straw and wood wool. When the particles are relatively larger in size, the boards produced by the process are known in the art under the general term of engineered wood. These engineered woods include panels, laminated strand lumber, oriented strand board, parallel strand lumber, and laminated veneer lumber. When the lignocellulosic particles are relatively smaller, the boards are known in the art as particleboard and fiber board.

The engineered wood products were developed because of the increasing scarcity of suitably sized tree trunks for cutting lumber. Such products can have advantageous physical properties such as strength and stability. Another advantage of the engineered wood and particle boards is that they can be made from the waste material generated by processing other wood and lignocellulosic materials. This leads to efficiencies and energy savings from the recycling process, and saves landfill space.

Binder resin compositions that have been used in making such composite wood products include phenol formaldehyde resins, urea formaldehyde resins and isocyanates resins. Isocyanate binders are commercially desirable because they have low water absorption, high adhesive and cohesive strength, flexibility in formulation, versatility with respect to cure temperature and rate, excellent structural properties, the ability to bond with lignocellulosic materials having high water contents, and no formaldehyde emissions. The disadvantages of isocyanates are difficulty in processing due to their high reactivity, adhesion to platens, lack of cold tack, high cost and the need for special storage.

It is known to treat lignocellulosic materials with polymethylene poly(phenyl isocyanates) (polymeric MDI or PMDI) to improve the strength of the product. Typically, such treatment involves applying the isocyanate to the material and allowing the isocyanate to cure, either by application of heat and pressure or at room temperature. While it is possible to allow the polymeric MDI to cure under ambient conditions, residual isocyanate groups remain on the treated products for weeks or even months in some instances. It is also known, but generally less acceptable from an environmental standpoint, to utilize toluylene diisocyanate for such purposes. Isocyanate prepolymers are among the preferred isocyanate materials that have been used in binder compositions to solve various processing problems, particularly adhesion to press platens and high reactivity.

In the past, various solvents have been added to the polyisocyanate resin with the aim of achieving a lower viscosity and better handling properties. After application, the solvent generally evaporates during the molding process, leaving the bound particles behind. One major disadvantage of prior art solvents is that they cause a reduction in the physical properties of the formed board including a reduction in the internal bond strength of the formed board.

Another major processing difficulty encountered with the related art isocyanate resin is the rapid reaction of the isocyanate with water present in the lignocellulosic material and any water present in the binder resin itself. One method for minimizing this difficulty is to use only lignocellulosic materials having a low moisture content (i.e., a moisture content of from about 3 to about 8%). This low moisture content is generally achieved by drying the lignocellulosic raw material to reduce the moisture content. Such drying is, however, expensive and has a significant effect upon the economics of the process. Use of materials having low moisture contents is also disadvantageous because panels made from the dried composite material tend to absorb moisture and swell when used in humid environments.

The problems of the rapid reaction of the isocyanate with water can be aggravated by adding diluents that are hydrophilic or hydroscopic to the isocyanate resin. Addition of these materials to the binder can draw entrained moisture in the wood or in the manufacturing environment to come into more intimate contact with the isocyanate resulting in pre-cure of the resin prior to densification of the mat in the press.

Another related art approach to resolving the moisture and isocyanate reactivity problem is to coat lignocellulosic-containing raw materials having a moisture content of up to 20% with a prepolymer based on a diphenylmethane diisocyanate mixture. This prepolymer has a free isocyanate group content of about 15 to about 33.6% by weight and a viscosity of from 120 to 1000 mPa-s at 25° C. This prepolymer is prepared by reacting (1) about 0.05 to about 0.5 hydroxyl equivalents of a polyol having a functionality of from 2 to 8 and a molecular weight of from about 62 to about 2000 with (2) one equivalent of a polyisocyanate mixture containing (a) from 0 to about 50% by weight of PMDI and (b) about 50 to about 100% by weight isomer mixture of diphenylmethane diisocyanate containing 10 to 75% by weight of 2,4′-diphenylmethane diisocyanate and 25 to 90% by weight of 4,4′-diphenylmethane diisocyanate. However, these approaches did not incorporate any release agents, such as phosphate acids or phosphate acid derivatives. Therefore, the lignocellulosic particles have a tendency to stick to the presses while being formed and results in unusable boards.

Other processes employ isocyanate terminated prepolymers made from a mixture of monomeric and polymeric MDI and an isocyanate-reactive material having at least one hydroxyl group and a molecular weight of from about 62 to about 6,000. These prepolymers are suitable for forming composites with higher moisture levels in the lignocellulose materials ranging from 10 to 50% by weight.

It has been known that polyisocyanate resins have excellent adhesion properties and workability as the adhesive for thermo-compression molded articles such as particle boards and medium-quality fiber boards produced from a lignocellulose type material such as wood chips, wood fibers, and the articles exhibit excellent physical properties. However, the excellent adhesiveness of the polyisocyanate resins causes the disadvantage that the compression molded article adheres firmly to the contacting metal surface of the heating plate in a continuous or batch thermo-compression process.

To solve the disadvantages of the undesired adhesion to the heating and/or pressing plate, it is required that a releasing agent be employed. One method of employing the release agent is to spray the release agent onto the plates to form a releasing layer. Other methods include incorporating phosphate acid and phosphate acid derivates into the isocyanate resin to help release the composite material from the plates after pressing. Illustrative examples of these methods are disclosed in U.S. Pat. Nos. 4,257,995; 4,257,996; and 4,258,169. However, as discussed above, the reactivity of the PMDI is such that the stability and storage life of the binder expires within a relatively short time period, such as less than 24 hours.

Accordingly, it would be advantageous to provide a lignocellulosic composite material formed from a binder resin having a modified internal release agent that results in improved stability and storage life of the binder resin. Further, it would be advantageous to provide a binder resin that is capable of performing multiple presses without any of the lignocellulosic material sticking to the plates.

### BRIEF SUMMARY OF THE INVENTION

The subject invention provides a lignocellulosic composite material and a method for preparing the lignocellulosic composite material. The method includes the steps of forming a release agent by combining a first component with a second component. The first component has hydroxyl groups and comprises i) an acid phosphate having the general formulas of: 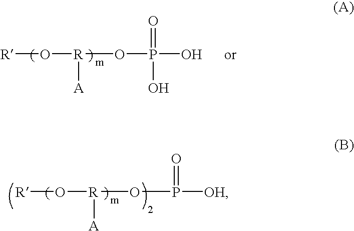
ii) a pyrophosphate derived from the acid phosphates (i), or a mixture thereof. R is selected from the group consisting of an alkyl having from 1 to 10 carbon atoms, an alkenyl having from 1 to 10 carbon atoms, an alkynyl having from 1 to 10 carbon atoms, and combinations thereof, and R′ is selected from the group consisting of an alkyl having at least 3 carbon atoms, an alkenyl having at least 3 carbon atoms, an aryl, an aryl substituted by at least one alkyl, an alkyl substituted by from 1 to 2 acyloxy groups, wherein the acyl group is the residue of an aliphatic monocarboxylic acid having at least 2 carbon atoms, and combinations thereof. A is selected from the group consisting of a hydrogen, a methyl, an ethyl, and a propyl, and m is a number having an average value from 0 to 25. The second component is a polyisocyanate present in an amount to provide isocyanate groups in excess of the hydroxyl groups for reacting with the first component.

A binder resin is formed by combining a polyisocyanate component with the release agent in an amount sufficient to produce the binder resin having an acid phosphate or acid phosphate derivative content of from 2 to 20 parts by weight based on 100 parts of the binder resin. The binder resin is mixed with lignocellulosic particles to form a lignocellulosic mixture. The lignocellulosic mixture comprises the lignocellulosic particles in an amount of from about 75 to 99 parts by weight based on 100 parts by weight of the lignocellulosic mixture and the binder resin in an amount of from 1 to 25 parts by weight based on 100 parts by weight of the lignocellulosic mixture. A lignocellulosic composite material is formed by compressing the lignocellulosic mixture at an elevated temperature and under pressure.

The subject invention provides a lignocellulosic composite material formed from a binder resin having an internal release agent that has been passivated and that results in improved stability and storage life of the binder resin. Further, the binder resin formed according to the subject invention is capable of performing multiple presses with minimal amount of sticking of any of the lignocellulosic material to the plates of the presses.

### DETAILED DESCRIPTION OF THE INVENTION

A lignocellulosic composite material and a method for preparing the lignocellulosic composite material are disclosed. The composite material includes lignocellulosic particles and a binder resin that is a mixture of a polyisocyanate component and a release agent. Throughout the present specification and claims, the terms compression molded, compressed, or pressed are intended to refer to the same process whereby the material is formed by either compression molding the material in a mold or by using compression as between a pair of plates from a press. In both procedures, pressure and heat are used to form the material and to set the binder.

The lignocellulosic particles can be derived from a variety of sources. They can come from wood and from other products such as bagasse, straw, flax residue, nut shells, cereal grain hulls, and mixtures thereof. Non-lignocellulosic materials in flake, fibrous or other particulate form, such as glass fiber, mica, asbestos, rubber, plastics and the like, can be mixed with the lignocellulosic material. The lignocellulosic particles can come from the process of comminuting small logs, industrial wood residue, branches, or rough pulpwood into particles in the form of sawdust, chips, flakes, wafer, strands, medium density fibers (MDF), and the like. They can be prepared from various species of hardwoods and softwoods. The lignocellulosic particles may have a moisture content of from 2 to 15 weight percent. In a further preferred embodiment, the water content is from 3 to 12 weight percent, and most preferably from 4 to 10 weight percent. The water assists in the curing or setting of the binder resin.

The lignocellulosic particles can be produced by various conventional techniques. For example, pulpwood grade logs can be converted into flakes in one operation with a conventional roundwood flaker. Alternatively, logs and logging residue can be cut into fingerlings on the order of about 0.5 to 3.5 inches long with a conventional apparatus, and the fingerlings flaked in a conventional ring type flaker. The logs are preferably debarked before flaking.

The dimensions of the lignocellulosic particles are not particularly critical. Flakes commonly have an average length of about 2 to 6 inches, and average width of about 0.25 to 3 inches, and an average thickness of about 0.005 to about 0.05 inches. Strands which are about 1.5 inches wide and 4.7 inches long can be used to make laminated strand lumber, while strands about 0.12 inches wide and 9.8 inches long can be used to make parallel strand lumber. The lignocellulosic particles can be further milled prior to use in the process of the invention, if such is desired to produce a size more suitable for producing the desired article. For example, hammer, wing beater, and toothed disk mills may be used.

In the subject invention, the lignocellulosic particles are present in an amount of from about 75 to 99 parts by weight based on 100 parts by weight of the material, preferably from about 80 to 99 parts by weight based on 100 parts by weight of the material, and most preferably 85 to 99 parts by weight based on 100 parts by weight of the material.

The binder resin is a mixture of the polyisocyanate component and the release agent. The binder resin is present in an amount of from 1 to 25 parts by weight based on 100 parts by weight of the material, whereby the remainder is the lignocellulosic particles. However, it is to be appreciated that other filler may be added, such as wax, defoamers, and the like. In a preferred embodiment, the binder resin is present in an amount of from 1 to 20 parts by weight based on 100 parts by weight of the material, and more preferably from 1 to 15 parts by weight based on 100 parts by weight of the material. When the binder resin is added to the lignocellulosic material, the binder resin should have a viscosity between 150 and 250 centipoise at 25° C. When the viscosity of the binder resin is within this range, then the lignocellulosic material will be sufficiently coated with the polyisocyanate component to have good physical properties and the release agent will be in sufficient contact with the presses to ensure a clean release of the material from the presses. One major disadvantage of the prior art resins and release agents is that their viscosity increases over a short period of time. If the resins and release agents are not used shortly after being made, such as within 24 hours, the viscosity of the binder resin increases to a point where it is no longer useable. This is especially difficult for commercial production of the lignocellulosic material because any non-useable binder resin has to be discarded which increases the cost of manufacturing the material. Therefore, maintaining the viscosity within the desired ranges results in a successful lignocellulosic composite material that is cost effective in large scale, commercial production.

The polyisocyanate component that may be used in forming the binder resin includes aliphatic, alicyclic and aromatic polyisocyanates characterized by containing two or more isocyanate groups. Such polyisocyanates include the diisocyanates and higher functionality isocyanates, particularly the aromatic polyisocyanates. Mixtures of polyisocyanates which may be used include, crude mixtures of di- and higher functionality polyisocyanates produced by phosgenation of aniline-formaldehyde condensates or as prepared by the thermal decomposition of the corresponding carbamates dissolved in a suitable solvent, as described in U.S. Pat. No. 3,962,302 and U.S. Pat. No. 3,919,279, the disclosures of which are incorporated herein by reference, both known as crude diphenylmethane diisocyanate (MDI) or polymeric MDI (PMDI). The polyisocyanate may be an isocyanate-terminated prepolymer made by reacting, under standard conditions, an excess of a polyisocyanate with a polyol which, on a polyisocyanate to polyol basis, may range from about 20:1 to 2:1. The polyols include, for example, polyethylene glycol, polypropylene glycol, diethylene glycol monobutyl ether, ethylene glycol monoethyl ether, triethylene glycol, etc., as well as glycols or polyglycols partially esterified with carboxylic acids including polyester polyols and polyether polyols.

The polyisocyanates or isocyanate-terminated prepolymers may also be used in the form of an aqueous emulsion by mixing such materials with water in the presence of an emulsifying agent. The isocyanate compound may also be a modified isocyanate, such as, carbodiimides, allophanates, isocyanurates, and biurets.

Also illustrative of the di- or polyisocyanates which may be employed are, for example: toluene-2,4- and 2,6-diisocyanates or mixtures thereof; diphenylmethane-4,4′-diisocyanate and diphenylmethane-2,4′-diisocyanate or mixtures of the same, the mixtures preferably containing about 10 parts by weight 2,4′- or higher, making them liquid at room temperature; polymethylene polyphenyl isocyanates; naphthalene-1,5-diisocyanate; 3,3′-dimethyl diphenylmethane-4,4′-diisocyanate; triphenyl-methane triisocyanate; hexamethylene diisocyanate; 3,3′-ditolylene-4,4-diisocyanate; butylene 1,4-diisocyanate; octylene-1,8-diisocyanate; 4-chloro-1,3-phenylene diisocyanate; 1,4-, 1,3-, and 1,2-cyclohexylene diisocyanates; and, in general, the polyisocyanates disclosed in U.S. Pat. No. 3,577,358, the disclosure of which is incorporated herein by reference. Preferred polyisocyanates include polymeric diphenylmethyl diisocyanate and monomeric diphenylmethane diisocyanate being at least one of diphenylmethane-4,4′-diisocyanate, diphenylmethane-2,4′-diisocyanate, and diphenylmethane-2,2′-diisocyanate. Most preferably, the polyisocyanate component is polymeric diphenylmethyl diisocyanate. One example of the preferred polyisocyanate is, but not limited to, Lupranate® M20S, commercially available from BASF Corporation.

The polyisocyanate is present in the binder resin in an amount of from about 60 to 99.5 parts by weight based on 100 parts by weight of the binder resin. When too little polyisocyanate is utilized, then the resulting lignocellulosic material does not have the necessary physical properties to be commercially successful. Likewise, when too much polyisocyanate is utilized, the lignocellulosic material does not cleanly release from the plates and increases the cost of manufacturing the material. In a preferred embodiment, the polyisocyanate is present in an amount of from about 60 to 90 parts by weight based on 100 parts by weight of the binder resin, and most preferably from about 60 to 85 parts by weight based on 100 parts by weight of the binder resin.

The polyisocyanate is mixed with the release agent, which is the reaction product of a first component and a second component. The first component has hydroxyl groups and the second component has isocyanate groups in excess of the hydroxyl groups. The excess isocyanate groups of the second component passivate the first component and therefore allow the first component to be combined with a polyisocyanate to afford a binder resin with improved storage stability. The binder resin has an NCO content of from 20 to 40 percent. It is believed, without limiting the subject invention, that the hydroxyl groups of the first component react with the excess isocyanate groups of the second component, resulting in the formation of pyrophosphates, anhydrides of the first component, and metaphosphates. The pyrophosphates and metaphosphates may function as phosphorylating agents during the pressing of the lignocellulosic article by reacting with hydroxyl groups on the surface of the wood and/or the surface of the metal platen, forming a hydrophobic layer between the two. This hydrophobic layer allows the lignocellulosic product to be released from the platens when the pressure is released. The release agent is present in an amount of from 0.5 to 40 parts by weight based on 100 parts by weight of the binder resin, preferably from 10 to 40 parts by weight based on 100 parts by weight of the binder resin, and most preferably 15 to 40 parts by weight based on 100 parts by weight of the binder resin.

Since it is desired that the binder resin have a final viscosity of between 150 and 350 centipoise at 25° C., the release agent must be formulated accordingly. The amount of the release agent used and the viscosity of the release agent impacts the final viscosity of the binder resin. Therefore, it is desired that the release agent have a viscosity between 50 and 500 centipoise at 25° C., preferably between 150 and 350 centipoise at 25° C., and most preferably between 170 and 250 centipoise at 25 ° C. When the desired amount of the release agent is mixed with the polyisocyanate, the final viscosity of the binder resin can be within the desired ranges, while also having an improved viscosity stability during storage.

It is believed, without limiting the subject invention, the release agent creates a hydrophobic layer between the lignocellulosic composite material and the plates and this hydrophobic layer allows for clean releases from the press. The first component used in forming the release agent is present in an amount of from 30 to 90 parts by weight based on 100 parts by weight of the release agent. If too much of the first component is present in the release agent, then the resultant lignocellulosic composite material will not have the required physical properties for the various applications. In a preferred embodiment, the first component is present in an amount of from 40 to 80 parts by weight based on 100 parts by weight of the release agent, and most preferably from 50 to 70 parts by weight based on 100 parts by weight of the release agent. The first component comprises i) an acid phosphate having the general formula of: 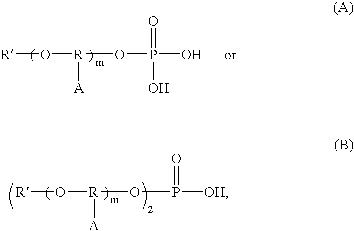
ii) a pyrophosphate derived from one or more of the acid phosphates (i), or mixtures thereof. In the above formulas (A), (B), R is selected from the group consisting of an alkyl having from 1 to 10 carbon atoms, an alkenyl having from 1 to 10 carbon atoms, an alkynyl having from 1 to 10 carbon atoms, and combinations thereof and R′ is selected from the group consisting of an alkyl having at least 3 carbon atoms, an alkenyl having at least 3 carbon atoms, an aryl, an aryl substituted by at least one alkyl, an alkyl substituted by from 1 to 2 acyloxy groups, wherein the acyl group is the residue of an aliphatic monocarboxylic acid having at least 2 carbon atoms, and combinations thereof. A is selected from the group consisting of a hydrogen, a methyl, an ethyl, and a propyl, and m is a number having an average value from 0 to 25.

In a most preferred embodiment, the first component is a mixture of the following general formulas: 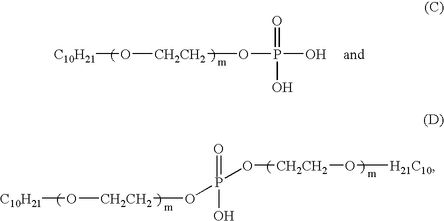
wherein m has an average value from 1 to 25. The composition of equation (C) is a monoester, while the composition of equation (D) is a diester. This mixture is a commercially available phosphoric acid ester surfactant, sold under the tradename MAPHOS® 60A, from BASF Corporation.

In another embodiment, the first component may be a mixture of the following general formulas: 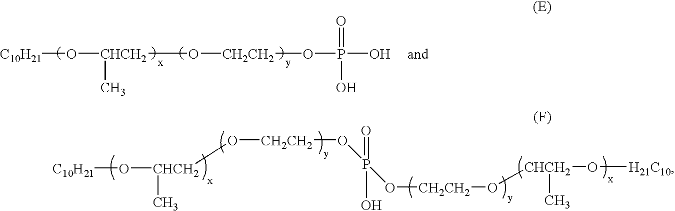
wherein x and y have an average value from 1 to 25.

In the general formula for the first component, when m is zero, then the first component is selected from at least one of i) an acid phosphate having the general formula of: 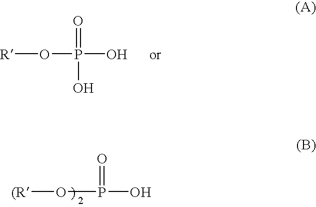
and ii) pyrophosphates represented by those derived from the acid phosphates (i) and mixtures of the acid phosphates (i). In the above formulas, R′ is selected from the group consisting of an alkyl having at least 3 carbon atoms, an alkenyl having at least 3 carbon atoms, an aryl, an aryl substituted by at least one alkyl, an alkyl substituted by from 1 to 2 acyloxy groups, wherein the acyl group is the residue of an aliphatic monocarboxylic acid having at least 2 carbon atoms, and combinations thereof. Most preferably, R′ has from 4 to 20 carbon atoms. It has been determined that when m is zero, a lower molecular weight composition is formed and additional releases are achieved. In another preferred embodiment, R′ has 8 carbon atoms and is a residue from 2-ethylhexyl alcohol. This mixture is a commercially available under the tradenames DURAPHOS® 2EHAP from Rhodia, Inc. and AMPHOS 1600, from JLK Industries, Inc.

It has been surprisingly discovered that the formation of the first component impacts the final stability of the binder resin. It has also been surprisingly discovered that the molecular weight of the alcohol used to prepare the first component has a significant effect of the release properties of the binder resin. In a preferred embodiment, the first component is formed from a mixture of phosphoric anhydride, P₂O₅, and an alcohol having a number-average molecular weight of less than 450. Utilizing the first component formed in such a manner in the binder resin provides improved stability and clean releases from the presses. In another preferred embodiment, the number-average molecular weight of the alcohol is less than 425, and most preferably less than 400. One preferred alcohol is an alkylene oxide adduct of a chain of from 2 to 20 carbon atoms. Examples of preferred alcohols include, but are not limited to, MACOL® W5, ICONOL® 24-3, and LUTENSOL® XP30, each commercially available from BASF Corporation. The acid phosphates prepared from these preferred alcohols have the general formula 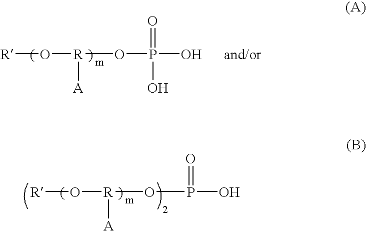
In which A is hydrogen, m is an integer from two to five, R is an alkyl having two carbons, and R′ is an alkyl or alkyl substituted aryl with eight to fourteen carbon atoms.

The first component is then passivated by being reacted with the second component. The passivation increases the stability of the binder resin and improves the storage life. It is believed that the excess number of the isocyanate groups present in the second component relative to the hydroxyl groups of the first component results in the formation of pyrophosphates, anhydrides of the first component, and metaphosphates. The pyrophosphates and metaphosphates are much less reactive with isocyanate groups, which results in a final binder resin having enhanced stability and an improved storage life. The second component is preferably monomeric diphenylmethane diisocyanate selected from at least one of diphenylmethane-4,4′-diisocyanate, diphenylmethane-2,4′-diisocyanate, and diphenylmethane-2,2′-diisocyanate. Many other polyisocyanates can also be used as the second component, but preferably the polyisocyanates should be of low viscosity, less than 200 centipoise at 25° C., and preferable less than 40 centipoise at 25° C. The second component is present in an amount of from 10 to 70 parts by weight based on 100 parts by weight of the release agent for reacting with the first component, preferably from 20 to 60 parts by weight based on 100 parts by weight of the release agent, and most preferably from 30 to 50 parts by weight based on 100 parts by weight of the release agent.

The method of forming the lignocellulosic composite material includes the steps of (a) forming the release agent by combining the first component with the second component having isocyanate groups in excess of the hydroxyl groups for reacting with the first component to passivate the mixture. Next, in step (b), the binder resin is formed by combining a polyisocyanate component with the release agent in an amount sufficient to produce a binder resin having an acid phosphate or acid phosphate derivative content of from about 2 to about 20 parts by weight based on 100 parts of the binder resin. The acid phosphate or derivative content ensures the clean release from the presses. If too little acid phosphate content is present, the composite material sticks to the presses and does not release cleanly. It too much is present, then the physical properties of the board are impacted. Preferably, the acid phosphate or acid phosphate derivative content is from about 3 to about 15 parts by weight based on 100 parts of the binder resin, and most preferably, the acid phosphate or acid phosphate derivative content is from about 4 to about 12 parts by weight based on 100 parts of the binder resin.

After the binder resin is formed, the lignocellulosic mixture is formed in step (c) by combining from about 75 to 99 parts by weight of the lignocellulosic particles based on 100 parts by weight of the lignocellulosic mixture with the binder resin in an amount of from 1 to 25 parts by weight based on 100 parts by weight of the lignocellulosic mixture. The lignocellulosic particles are resinated using the binder resin described above. The binder resin and the lignocellulosic particles are mixed or milled together during the formation of a resinated lignocellulosic mixture. Generally, the binder resin can be sprayed onto the particles while they are being agitated in suitable equipment. To maximize coverage of the particles, the binder resin is preferably applied by spraying droplets of the binder resin onto the particles as they are being tumbled in a rotary blender or similar apparatus. For example, the particles can be resinated in a rotary drum blender equipped with at least one spinning disk atomizer.

For testing on a lab scale, a simpler apparatus can suffice to resinate the particles. For example, a 5 gallon can is provided with baffles around the interior sides, and a lid with a hole large enough to receive the nozzle of a spray gun or other liquid delivery system, such as a pump sprayer. It is preferred that the binder resin be delivered as a spray. The particles to be resinated are placed in a small rotary blender. The blender is rotated to tumble the particles inside against the baffles, while the desired amount of binder resin is delivered with a spray device. After the desired amount of binder resin is delivered, the particles can be tumbled for a further time to effect the desired mixing of the particles with the binder resin.

The amount of binder resin to be mixed with the lignocellulosic particles in the resinating step is dependant upon several variables including, the binder resin used, the size, moisture content and type of particles used, the intended use of the product, and the desired properties of the product. The mixture produced during the resinating step is referred to in the art as a furnish. The resulting furnish, i.e., the mixture of flakes, binder resin, parting agent, and optionally, wax, wood preservatives and/or other additives, is formed into a single or multi-layered mat that is compressed into a particle board or flakeboard panel or another composite article of the desired shape and dimensions. The mat can be formed in any suitable manner. For example, the furnish can be deposited on a plate-like carriage carried on an endless belt or conveyor from one or more hoppers spaced above the belt. When a multi-layer mat is formed, a plurality of hoppers are used with each having a dispensing or forming head extending across the width of the carriage for successively depositing a separate layer of the furnish as the carriage is moved between the forming heads. The mat thickness will vary depending upon such factors as the size and shape of the wood flakes, the particular technique used in forming the mat, the desired thickness and density of the final product and the pressure used during the press cycle. The mat thickness usually is about 5 to 20 times the final thickness of the article. For example, for flakeboard or particle board panels of ½ inch thickness and a final density of about 35 lbs/ft³, the mat usually will be about 3 to 6 inches thick.

Finally, in step (d), the lignocellulosic composite material is formed by compressing the lignocellulosic mixture at an elevated temperature and under pressure. Press temperatures, pressures and times vary widely depending upon the shape, thickness and the desired density of the composite article, the size and type of wood flakes, the moisture content of the wood flakes, and the specific binder used. The press temperature can be from about 1000 to 300° C. To minimize generation of internal steam and the reduction of the moisture content of the final product below a desired level, the press temperature preferably is less than about 250° C. and most preferably from about 180° to about 240° C. The pressure utilized is generally from about 300 to about 800 pounds per square inch. Preferably the press time is from 120 to 350 seconds. The press time utilized should be of sufficient duration to at least substantially cure the binder resin and to provide a composite material of the desired shape, dimension and strength. For the manufacture of flakeboard or particle board panels, the press time depends primarily upon the panel thickness of the material produced. For example, the press time is generally from about 200 to about 300 seconds for a pressed article with a ½ inch thickness.

The following examples, illustrating the formation of the lignocellulosic composite material, according to the subject invention and illustrating certain properties of the lignocellulosic composite material, as presented herein, are intended to illustrate and not limit the invention.

### EXAMPLES

The following examples describe the formation of a lignocellulosic composite material by adding and reacting the following parts listed by weight, unless otherwise indicated. Table 1 illustrates the formation of the first component from various different alcohols.

TABLE 1
Formation of First Component of Release Agent

| | | | | Comparative | Comparative |
|---|---|---|---|---|---|
| | Example 1 | Example 2 | Example 3 | Example 1 | Example 2 |
| Phosphorus | 24.5 | 22.3 | 19.9 | NA | 12.1 |
| Pentaoxide | | | | | |
| Alcohol A | 75.5 | — | — | NA | — |
| Alcohol B | — | 77.7 | — | NA | — |
| Alcohol C | — | — | 80.1 | NA | — |
| Alcohol D | — | — | — | NA | 87.9 |

In Example 1, alcohol A is LUTENSOL® XP30, an alkoxylate based on the C₁₀ Guerbet alcohol, commercially available from BASF Corporation, having a molecular weight of about 273. The alcohol A was reacted with the phosphorus pentoxide to form a phosphoric acid ester, which is a mixture of mono and di-acid phosphate as follows: 500 g of alcohol A was heated to 60° C. in a 4-necked 1-liter round-bottomed flask equipped with high-speed shearer, heating mantle and mechanical stirrer. Next, 162.5 g of P₂O₅ was added in 2-3 g portions under inert atmosphere. Mechanical stirring was used continuously and the shearing device was engaged briefly after each addition. The addition rate was adjusted to keep the reaction temperature below 75° C. After the addition of P₂O₅ was complete, the mixture was allowed to react for 3 hours at 90° C., then cooled to room temperature.

In Example 2, alcohol B is ICONOL® 24-3, a mixture of alkoxylates based on C₁₀-C₁₄ alcohols, commercially available from BASF Corporation, having a molecular weight of about 309. The alcohol B was reacted with the phosphorus pentoxide to form a phosphoric acid ester, which is a mixture of mono and di-acid phosphate as follows: 500 g of alcohol B was heated to 60° C. in a 4-necked, 1-liter, round-bottomed flask equipped with high-speed shearer, heating mantle and mechanical stirrer. The phosphorus pentoxide (P₂O₅) was added in 2-3 g portions under inert atmosphere up to 143.5 g. Mechanical stirring was used continuously and the shearing device was engaged briefly after each addition. The addition rate was adjusted to keep the reaction temperature below 75° C. After the addition of P₂O₅ was complete, the mixture was allowed to react for 3 hours at 90° C., then cooled to room temperature.

In Example 3, alcohol C is MACOL® W5, an alkoxylate based on a C₁₀ alcohol, commercially available from BASF Corporation, having a molecular weight of about 361. The alcohol C was reacted with the phosphorus pentoxide to form a phosphoric acid ester, which is a mixture of mono and di-acid phosphate as follows: 500 g of alcohol C was heated to 60° C. in a 4-necked, 1-liter, round-bottomed flask equipped with high-speed shearer, heating mantle and mechanical stirrer. The phosphorus pentoxide (P₂O₅) was added in 2-3 g portions under inert atmosphere up to 123.9 g. Mechanical stirring was used continuously and the shearing device was engaged briefly after each addition. The addition rate was adjusted to keep the reaction temperature below 75° C. After the addition of P₂O₅ was complete, the mixture was allowed to react for 3 hours at 90° C., then cooled to room temperature. 100461 For Comparative Example 1, Maphos® M60 phosphate ester surfactant, commercially available from BASF Corporation, was used. The molecular weight of the alcohol used to prepare the ester is about 467. This is comparative example because the molecular weight of the alcohol used in this phosphate ester is higher than preferred. A release agent prepared from this phosphate ester does not afford a high number of clean releases when incorporated into a wood binder.

In Comparative Example 2, alcohol D is ICONOL® NP10, an alkoxylate based on a C₁₅ alcohol, commercially available from BASF Corporation. The ICONOL® NP10 is a comparative example because the alcohol has a molecular weight of about 643 which is higher than preferred. A release agent prepared from a phosphate acid ester made from this alcohol does not afford a high number of clean releases when incorporated into a wood binder. The alcohol D was reacted with the phosphorus pentoxide to form a phosphoric acid ester, which is a mixture of mono and di-acid phosphate as follows: 500 g of alcohol D was heated to 60° C. in a 4-necked, 1-liter, round-bottomed flask equipped with high-speed shearer, heating mantle and mechanical stirrer. Next, 69 g of P₂O₅ was added in 2-3 g portions under inert atmosphere. Mechanical stirring was used continuously and the shearing device was engaged briefly after each addition. The addition rate was adjusted to keep the reaction temperature below 75° C. After the addition of P₂O₅ was complete, the mixture was allowed to react for 3 hours at 90° C., then cooled to room temperature.

After forming the first component, the release agent is formed by reacting the first component with the second component. Table 2 illustrates the formation of the release agent, listed by weight, unless otherwise indicated.

TABLE 2
Formation of Release Agent

| | | | | | Comparative | Comparative |
|---|---|---|---|---|---|---|
| | Example 1 | Example 2 | Example 3 | Example 4 | Example 1 | Example 2 |
| First | 40.0 | 40.0 | 40.0 | — | 30.0 | 30.0 |
| Component | | | | | | |
| A | | | | | | |
| First | — | — | — | 25.0 | — | — |
| Component | | | | | | |
| B | | | | | | |
| Second | 60.0 | 60.0 | 60.0 | 75.0 | 70.0 | 70.0 |
| Component | | | | | | |

The first component A is the phosphoric acid derivative described in Table 1 for Examples 1, 2 and 3 and Comparative Examples 1 and 2. The first component B in Example 4 is DURAPHOS® 2EHAP phosphate ester, commercially available from Rhodia, Inc. The second component is a mixture of 4,4′ and 2,4′ isomers of monomeric MDI, sold under the tradename LUPRANATE® MI, commercially available from BASF Corporation.

In Examples 1-4 and Comparative Example 2, 120 g of the second component was heated to 60° C. in a 250 ml, 3-necked round bottomed flask equipped with mechanical stirrer and heating mantle. Then, 80 g of the first component A (from Table 1) was slowly added via addition funnel over 30 minutes under inert atmosphere. After the addition, the blend was allowed to react for 2 hours at 60° C. In Example 1, the viscosity of the product was 188 centipoise at 25° C., in Example 2, the viscosity of the product was 193.5 centipoise at 25° C., and in Example 3, the viscosity of the product was 186 centipoise at 25° C. In Example 4, the viscosity of the product was 5780 cP at 25° C. and was adjusted with 112.3 g more of the second component. In Comparative Example 2, the viscosity of the product was 620 centipoise at 25° C. and was adjusted by addition of 63.7 more of the second component. The final viscosity of the release agent in Comparative Example 2 was 219 centipoise at 25° C. In Comparative Example 1, 245 g of the second component and 105.3 g of the first component A (from Table 1) were blended and reacted as above resulting in a release agent with viscosity 123 centipoise at 25° C.

Each of the release agents was mixed into a binder resin according to the following table, listed by weight, unless otherwise indicated.

TABLE 3
Formation of Binder Resin

| | | | | | Comparative | Comparative |
|---|---|---|---|---|---|---|
| | Example 1 | Example 2 | Example 3 | Example 4 | Example 1 | Example 2 |
| Release Agent | 10.0 | 10.0 | 10.7 | 16.0 | 13.3 | 13.3 |
| A | | | | | | |
| Polyisocyanate | 90.0 | 90.0 | 89.3 | 84.0 | 86.7 | 86.7 |
| Component | | | | | | |

The release agent A is the product formed in Table 2. The polyisocyanate component is LUPRANATE® M20S, a polymeric MDI commercially available from BASF Corporation.

In Example 1 and 2, 33.5 g of the release agent A was blended with 300.0 g of the polyisocyanate component at room temperature in a 1-L, 3-necked, round-bottomed flask with mechanical stirrer and inert atmosphere. The blend was stirred for 15 minutes. The resultant binder had an amount of phosphate acid derivative of about 8% by weight based on 100% by weight of the binder.

In Example 3, 50.3 g of the release agent A was combined with 420.0 g of the polyisocyanate component at room temperature in a 1-L, e-necked, round-bottomed flask with mechanical stirrer and inert atmosphere. The blend was stirred for 15 minutes. The resultant binder had an amount of phosphate acid derivative of about 4% by weight based on 100% by weight of the binder.

In Example 4, 56 g of the release agent was combined with 294 g of the polyisocyanate component at room temperature in a 1-L, 3-necked, round-bottom flask with mechanical stirrer and inert atmosphere. The blend was stirred for 15 minutes. The resultant binder had an amount of phosphate acid derivative of about 4% by weight based on 100% by weight of the binder.

In Comparative Example 1, 46.7 g of the release Agent A was combined with 303.3 g of the polyisocyanate component at room temperature in a 1-L, 3-necked, round-bottom flask with mechanical stirrer and inert atmosphere. The blend was stirred for 15 minutes. The resultant binder had an amount of phosphate acid derivative of about 4% by weight based on 100% by weight of the binder.

In Comparative Example 2, 46.0 g of the release agent A was combined with 300.0 g of the polyisocyanate component at room temperature in a 1 -L, 3-necked, round-bottom flask with mechanical stirrer and inert atmosphere. The blend was stirred for 15 minutes. The resultant binder had an amount of phosphate acid derivative of about 4% by weight based on 100% by weight of the binder.

Each of the binder formulations listed in Table 3 was tested for release properties using the procedure described herein. Binder was applied to wood flakes using commercial spray equipment comprised of a large rotating bin with a spray delivery system. The wood flakes of aspen or pine and moisture content of 6-8% were tumbled in the bin as the binder was applied at a rate of about 300 grams per minute. The application lasted 1-2 minutes and tumbling continued for several minutes afterward to assure even distribution. The amount of binder used was such that the isocyanate component of the binder was consistently applied at 3% the weight of the dry wood. The wood flake was then laid by hand into a 6-inch by 9-inch deckle box atop the test platen, the box removed and the furnish then placed in the press. A second test platen was laid atop the furnish. The press, maintained at 410° F., was then engaged for 3 minutes. Maximum pressure obtained was 400-500 p.s.i. A pressed board made in this way was judged a “slight stick” or “manual assist” depending on whether it could be removed with a slight touch or required more assistance. A “hard stick” could not be removed.

The release properties of the binder resins formed are compared in the table below. The results illustrate the effect of the molecular weight of the alcohol used to make the phosphoric acid component of the release agent on the release properties of the wood binder. Surprisingly, the results in Table 4 demonstrate that phosphate acid esters can vary widely in their release properties. Phosphoric acid esters prepared from lower molecular weight alcohols, preferable less than about 450, afford excellent release properties when used as release agents in wood binders, even when used at the very low level of 4% by weight based on 100% by weight of the binder.

TABLE 4
Releasability of Wood Composite from Presses

| | | | | | Comparative | Comparative |
|---|---|---|---|---|---|---|
| | Example 1 | Example 2 | Example 3 | Example 4 | Example 1 | Example 2 |
| Slight | 1 | 2 | 5 | 0 | 7 | 7 |
| Sticks | | | | | | |
| Mechanical | 1 | 1 | 0 | 0 | 8 | 17 |
| Assistance | | | | | | |
| Sticks | | | | | | |
| Total # of | 38 | 37 | 37 | 36 | 37 | 37 |
| Presses | | | | | | |
| Total # of | 2 | 3 | 5 | 0 | 15 | 24 |
| Sticks | | | | | | |
| % Clean | 95 | 92 | 86 | 100 | 59 | 35 |
| Releases | | | | | | |
| MW | 273 | 309 | 361 | 130 | 467 | 643 |
| Alcohol | | | | | | |

Additionally, samples were prepared for a study to compare the stability of binder resins made using the release agents of the invention (the product formed in Table 2) or made using only the first component A (the phosphate acid esters given in Table 2). The release agents or first components were then mixed with the polyisocyanate component, as listed in the following table by weight, unless otherwise indicated. Compared to Examples 5 and 6 (see Table 5), the first component used in Comparative Examples 3-4 has not been passivated by reaction with excess isocyanate groups.

TABLE 5
Formation of Binder Resin for Stability Tests

| | | | Comparative | Comparative |
|---|---|---|---|---|
| | Example 5 | Example 6 | Example 3 | Example 4 |
| First Component | — | — | 10.0 | 8.0 |
| from Table 2 | | | | |
| (Wt %) | | | | |
| Release Agent | 25 | 21 | — | — |
| from Table 2 | | | | |
| (Wt %) | | | | |
| Polyisocyanate | 75 | 79 | 90.0 | 92.0 |
| Component | | | | |
| (Wt %) | | | | |
| Total Binder | 100 | 100 | 100 | 100 |
| (Wt %) | | | | |
| Phosphate acid | 10.0 | 8.5 | 10.0 | 8.0 |
| ester in binder | | | | |
| (Wt %) | | | | |

The polyisocyanate component is LUPRANATE® M20S, commercially available from BASF Corporation.

In Example 5, 28.33 g of the release agent A (Table 2, Example 1) was combined with 85 g of the polyisocyanate component in a 4-oz bottle and manually agitated until well dispersed. The resultant binder had an amount of phosphate acid derivative of about 10% by weight based on 100% by weight of the binder.

In Example 6, 114.3 g of the release agent A (Table 2, Example 3) was blended with 420 g of the polyisocyanate component at room temperature in a 1-L, 3-necked, round-bottomed flask with mechanical stirrer and inert atmosphere. The blend was stirred for 15 minutes. The resultant binder had an amount of phosphate acid derivative of about 8% by weight based on 100% by weight of the binder.

In Comparative Example 3, the binder resin had an amount of phosphate acid derivative of about 10% by weight based on 100% by weight of the binder. To form the binder resin, 10.0 g of the first component formed in Example 1 was combined with 90.0 g of the polyisocyanate component in a 4-oz bottle and manually agitated until well dispersed.

In Comparative Example 4, the binder resin had an amount of phosphate acid derivative of about 8% by weight based on 100% by weight of the binder. To form the binder resin, 11.4 g of the first component formed in Example 3 was combined with 131.0 g of the polyisocyanate component in a 4-oz bottle and manually agitated until well dispersed.

Each of the above Examples and Comparative Examples were stored and monitored for stability and for storage life based upon viscosity in centipoise at 25° C.

TABLE 6
Stability Testing of Binder Resins

| | Example | Comparative | Example | Comparative |
|---|---|---|---|---|
| | 5 | Example 3 | 6 | Example 4 |
| Alcohol used to | A | A | C | C |
| prepared the | | | | |
| First Component | | | | |
| (phosphate acid | | | | |
| ester) | | | | |
| Passivated by | Yes | No | Yes | No |
| reaction with | | | | |
| Second Component? | | | | |
| Viscosity | 176 | 248 | 168 | 275 |
| (@ 25° C.) | | | | |
| after 1 day | | | | |
| storage. | | | | |
| Viscosity | 193 | 274 | 190 | 325 |
| (@ 25° C.) | | | | |
| after 8 days | | | | |
| storage. | | | | |
| Viscosity | 279 | 470 | 209 | 458 |
| (@ 25° C.) | | | | |
| after 15 days | | | | |
| storage. | | | | |
| Storage | 25/40 | 25/40 | 25 | 25 |
| Temperature, | | | | |
| ° C. | | | | |
| Storage Time | 8/8 days | 8/8 days | 15 days | 15 days |
| Viscosity | 66.0 | 102.0 | 24.4 | 66.5 |
| Increase | | | | |
| (%) | | | | |

From the above, the binder resins formed according to the subject invention had improved stability and increased storage life. Example 5 and Comparative Example 3, the prepared binder resins were stored at 25° C. for eight days and then stored at 40° C. for another eight days. After the first eight days, the binder resin of Example 4 had a viscosity of 193 centipoise (cP) whereas the non-passivated binder resin of Comparative Example 3 had a viscosity of 274 cP. After fifteen days, the binder resin of Example 5 had a viscosity of 279 cP, whereas the non-passivated binder resin of Comparative Example 3 had a viscosity of 470 cP. In Example 6 and Comparative Example 4, Example 6 had a viscosity of 209 cP, whereas the non-passivated binder resin of Comparative Example 4 had a viscosity of 458 cP after fifteen days at 25° C.

The increase in viscosity shown in the Comparative Examples results in the binder resin having very limited storage stability. The binder resins not formed according to the subject invention must therefore be used within the same day of formulation. The binder resins formed according to the subject invention are capable of use up to at least two weeks after formulation, thereby having an increased storage life. The increased storage life is indicative of the improved stability of the composition.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

1. A method for preparing a lignocellulosic composite material, said method comprising the steps of:
a) forming a release agent by combining a first component having hydroxyl groups and comprising i) an acid phosphate having the general formulas of: 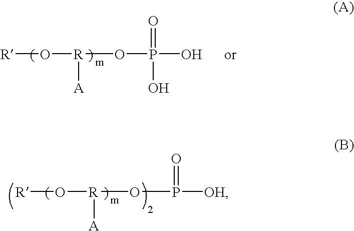
ii) a pyrophosphate derived from one or more of the acid phosphates (i), or a mixture thereof,
wherein R is selected from the group consisting of an alkyl having from 1 to 10 carbon atoms, an alkenyl having from 1 to 10 carbon atoms, an alkynyl having from 1 to 10 carbon atoms, and combinations thereof, R′ is selected from the group consisting of an alkyl having at least 3 carbon atoms, an alkenyl having at least 3 carbon atoms, an aryl, an aryl substituted by at least one alkyl, an alkyl substituted by from 1 to 2 acyloxy groups, wherein the acyl group is the residue of an aliphatic monocarboxylic acid having at least 2 carbon atoms, and combinations thereof, A is selected from the group consisting of a hydrogen, a methyl, an ethyl, and a propyl, and m is a number having an average value from 0 to 25,
with a second component having isocyanate groups in an amount such that the isocyanate groups are in excess of the hydroxyl groups;
b) forming a binder resin by combining a polyisocyanate component with the release agent, wherein the binder resin comprises from 0.5 to 40 parts by weight, based on 100 parts of the binder resin, of the acid phosphate, pyrophosphate, or mixture thereof;
c) forming a lignocellulosic mixture comprising lignocellulosic particles in an amount of from about 75 to 99 parts by weight and the binder resin in an amount of from 1 to 25 parts by weight, based on 100 parts by weight of the lignocellulosic mixture; and
d) forming a lignocellulosic composite material by compressing the lignocellulosic mixture at an elevated temperature and under pressure.

2. The method as set forth in claim 1 wherein the release agent has a viscosity between 50 and 500 centipoise at 25° C.

3. The method as set forth in claim 1 wherein the release agent has a viscosity between 150 and 250 centipoise at 25° C.

4. The method as set forth in claim 1 wherein the binder resin has a viscosity between 150 and 250 centipoise at 25° C.

5. The method as set forth in claim 1 wherein the step of forming the release agent comprises combining the first component in an amount of from 30 to 90 parts by weight based on 100 parts by weight of the release agent with the second component in an amount of from 10 to 70 parts by weight based on 100 parts by weight of the release agent.

6. The method as set forth in claim 5 wherein the step of forming the binder resin comprises combining the polyisocyanate component in an amount of from about 60 to 99.5 parts by weight based on 100 parts by weight of the binder resin with the release agent in an amount of from 0.5 to 40 parts by weight based on 100 parts by weight of the binder resin.

7. The method as set forth in claim 1 wherein the second component comprises a monomeric diphenylmethane diisocyanate.

8. The method as set forth in claim 7 wherein the second component comprises diphenylmethane-4,4′-diisocyanate, diphenylmethane-2,4′-diisocyanate, diphenylmethane-2,2′-diisocyanate or a mixture thereof.

9. The method as set forth in claim 1 wherein the polyisocyanate component comprises polymeric diphenylmethyl diisocyanate, monomeric diphenylmethane diisocyanate or a mixture thereof.

10. The method as set forth in claim 9 wherein the monomeric diphenylmethane diisocyanate comprises diphenylmethane-4,4′-diisocyanate, diphenylmethane-2,4′-diisocyanate, diphenylmethane-2,2′-diisocyanate, or a mixture thereof.

11. The method as set forth in claim 1 wherein the polyisocyanate comprises polymeric diphenylmethyl diisocyanate.

12. The method as set forth in claim 1 further comprising the step of preparing the first component from a mixture of phosphoric anhydride and an alcohol having a number-average molecular weight of less than 450.

13. The method as set forth in claim 12 wherein the step of preparing the first component comprises preparing the first component from a mixture of phosphoric anhydride and an alcohol being an alkylene oxide adduct of a chain of from 2 to 20 carbon atoms.

14. A lignocellulosic composite material comprising:
lignocellulosic particles in an amount of from about 75 to 99 parts by weight based on 100 parts by weight of said material;
a binder resin in an amount of from 1 to 25 parts by weight based on 100 parts by weight of said material, said binder resin comprising;
a polyisocyanate component in an amount of from about 60 to 99.5 parts by weight based on 100 parts by weight of said binder resin, and
a release agent in an amount of from 0.5 to 40 parts by weight based on 100 parts by weight of said binder resin, said release agent comprising the reaction product of,
a first component having hydroxyl groups and comprising from 30 to 90 parts by weight, based on 100 parts by weight of said release agent, of i) an acid phosphate having the general formula of: 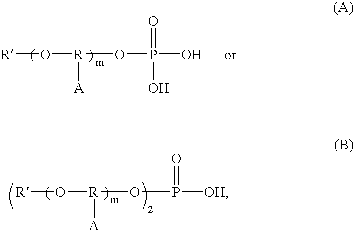
ii) a pyrophosphate derived from one or more of said acid phosphates (i), or a mixture thereof,
wherein R is selected from the group consisting of an alkyl having from 1 to 10 carbon atoms, an alkenyl having from 1 to 10 carbon atoms, an alkynyl having from 1 to 10 carbon atoms, and combinations thereof, R′ is selected from the group consisting of an alkyl having at least 3 carbon atoms, an alkenyl having at least 3 carbon atoms, an aryl, an aryl substituted by at least one alkyl, an alkyl substituted by from 1 to 2 acyloxy groups, wherein the acyl group is the residue of an aliphatic monocarboxylic acid having at least 2 carbon atoms, and combinations thereof, A is selected from the group consisting of a hydrogen, a methyl, an ethyl, and a propyl, and m is a number having an average value from 0 to 25; and
a second component having isocyanate groups in an amount of from 10 to 70 parts by weight based on 100 parts by weight of said release agent.

15. The material as set forth in claim 14 wherein said release agent has a viscosity between 50 and 500 centipoise at 25° C.

16. The material as set forth in claim 14 wherein said release agent has a viscosity between 150 and 250 centipoise at 25° C.

17. The material as set forth in claim 14 wherein said binder resin has a viscosity between 150 and 250 centipoise at 25° C.

18. The material as set forth in claim 14 wherein said second component comprises monomeric diphenylmethane diisocyanate.

19. The material as set forth in claim 18 wherein said monomeric diphenylmethane diisocyanate comprises diphenylmethane-4,4′-diisocyanate, diphenylmethane-2,4′-diisocyanate, diphenylmethane-2,2′-diisocyanate, or a mixture thereof.

20. The material as set forth in claim 14 wherein said polyisocyanate component comprises polymeric diphenylmethyl diisocyanate, monomeric diphenylmethane diisocyanate, or a mixture thereof.

21. The material as set forth in claim 20 wherein said monomeric diphenylmethane diisocyanate comprises diphenylmethane-4,4′-diisocyanate, diphenylmethane-2,4′-diisocyanate, diphenylmethane-2,2′-diisocyanate, or a mixture thereof.

22. The material as set forth in claim 14 wherein said polyisocyanate component comprises polymeric diphenylmethyl diisocyanate.

23. The material as set forth in claim 14 wherein said first component comprises a mixture of phosphoric anhydride and an alcohol having a number-average molecular weight of less than 450.

24. The material as set forth in claim 23 wherein the alcohol comprises an alkylene oxide adduct of a chain of from 2 to 20 carbon atoms.

25. A release agent for use in forming a lignocellulosic composite material, said composition comprising:
a first component having hydroxyl groups and comprising i) an acid phosphate having the general formulas of: 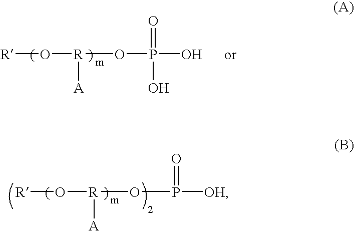
ii) a pyrophosphate derived from one or more of the acid phosphates (i), or a mixture thereof, wherein R is selected from the group consisting of an alkyl having from 1 to 10 carbon atoms, an alkenyl having from 1 to 10 carbon atoms, an alkynyl having from 1 to 10 carbon atoms, and combinations thereof, R′ is selected from the group consisting of an alkyl having at least 3 carbon atoms, an alkenyl having at least 3 carbon atoms, an aryl, an aryl substituted by at least one alkyl, an alkyl substituted by from 1 to 2 acyloxy groups, wherein the acyl group is the residue of an aliphatic monocarboxylic acid having at least 2 carbon atoms, and combinations thereof, A is selected from the group consisting of a hydrogen, a methyl, an ethyl, and a propyl, and m is a number having an average value from 0 to 25; and
a second component having isocyanate groups in an amount such that the isocyanate groups are in excess of the hydroxyl groups;

26. The release agent as set forth in claim 25 wherein the release agent has a viscosity between 50 and 500 centipoise at 25° C.

27. The release agent as set forth in claim 25 wherein the release agent has a viscosity between 150 and 250 centipoise at 25° C.

28. The release agent as set forth in claim 25 wherein said first component is present in an amount of from 30 to 90 parts by weight based on 100 parts by weight of the release agent.

29. The release agent as set forth in claim 28 wherein said second component is present in an amount of from 10 to 70 parts by weight based on 100 parts by weight of the release agent.

30. The release agent as set forth in claim 25 wherein said first component is formed from a mixture of phosphoric anhydride and an alcohol having a number-average molecular weight of less than 450.

31. The release agent as set forth in claim 30 wherein said first component is formed from a mixture of phosphoric anhydride and an alcohol being an alkylene oxide adduct of a chain of from 2 to 20 carbon atoms.

32. The release agent as set forth in claim 25 wherein said second component comprises a monomeric diphenylmethane diisocyanate.
